(19) United States
(12) Patent Application Publication
(10) Pub. No.: US 2017/0154111 A1
(43) Pub. Date: Jun. 1, 2017

(54) MANAGING ITEM LIFE-CYCLE AT HOME WITH INTERNET OF THINGS

(71) Applicant: International Business Machines Corporation, Armonk, NY (US)

(72) Inventors: Maximilien P. M. A. de Bayser, Rio de Janeiro (BR); Silvia C. S. Bianchi, Sao Paulo (BR); Carlos H. Cardonha, Sao Paulo (BR); Paulo R. Cavalin, Rio de Janeiro (BR); Maira Gatti de Bayser, Rio de Janeiro (BR); Luis G. Moyano, Rio de Janeiro (BR); Vagner Figueredo de Santana, SAO PAULO (BR); Marcelo Nery dos Santos, Rio de Janeiro (BR); Vinicius Costa Villas Boas Segura, Rio de Janeiro (BR); Bianca Zadrozny, Rio de Janeiro (BR)

(21) Appl. No.: 14/953,838

(22) Filed: Nov. 30, 2015

(51) Int. Cl. G06F 17/30; G06N 5/02

(52) U.S. Cl. CPC G06F 17/30864; G06N 5/02

(57) ABSTRACT

A system for managing items. The system includes a sensor for identifying a first physical object and a second physical object in a building. A computer interface in communication with the sensor is configured to receive a first identification of the first physical object and a second identification of the second physical object. A computer with at least one central processing unit is configured to automatically search for trend information about the first physical object, determine a first interaction between the first physical object and the second physical object based on the first identification of the first physical object and the second identification of the second physical object, and recommend disposition of the first physical object based on the first interaction between the first physical object and the second physical object, and the trend information about the first physical object.

### BACKGROUND

The present invention relates generally to life-cycle management and recommendation of personal items based on item interactions.

Currently, people own a vast collection of personal belongings, such as clothes, electronic, household devices, and so forth. Every now and them, some items need to be replaced, since they become outdated, worn-out, or simply no longer desired by the user.

### BRIEF SUMMARY

Accordingly, aspects of the present invention may provide for management and recommendation of personal items. Embodiments of the invention may handle the current collection of items of the person, and recommend when and for which new object an item of the individual's belongings should be replaced.

One example aspect of the present invention is a system for managing items. The system includes a sensor for identifying a first physical object and a second physical object in an environment. A computer interface in communication with the sensor is configured to receive a first identification of the first physical object and a second identification of the second physical object. A computer with at least one central processing unit is configured to automatically search for trend information about the first physical object, determine a first interaction between the first physical object and the second physical object based on the first identification of the first physical object and the second identification of the second physical object, and recommend disposition of the first physical object based on the first interaction between the first physical object and the second physical object, and the trend information about the first physical object.

Another example aspect of the present invention is a method for managing items. The method includes sensing by a sensor a first identification of a first physical object and a second identification of a second physical object in a building. A receiving operation receives, at a computer interface in communication with the sensor, the first identification of the first physical object and the second identification of the second physical object. A searching operation automatically searches for trend information about the first physical object. At a determining operation, a first interaction between the first physical object and the second physical object is determined based on the first identification of the first physical object and the second identification of the second physical object. A recommending operation recommends disposition of the first physical object based on the first interaction between the first physical object and the second physical object, and the trend information about the first physical object.

A further example aspect of the present invention is a computer program product for monitoring traffic characteristics between gateways in a computer network. The computer program product includes computer readable program code configured to: receive at a computer interface in communication with a sensor a first identification of a first physical object and a second identification of a second physical object, automatically search for trend information about the first physical object, determine a first interaction between the first physical object and the second physical object based on the first identification of the first physical object and the second identification of the second physical object, recommend disposition of the first physical object based on the first interaction between the first physical object and the second physical object, and the trend information about the first physical object, and store at a database identification information for the first physical object and the second physical object, descriptive information about the first physical object and the second physical object, time of ownership information about the first physical object and the second physical object, and descriptive information about the first interaction between the first physical object and the second physical object.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows one embodiment of a system for managing items, as contemplated by the present invention.

FIG. 2 shows one embodiment of a method for managing items, as contemplated by the present invention.

FIG. 3 shows another system for managing items, as contemplated by the present invention.

FIG. 4 shows one embodiment for managing interactions by the system, as contemplated by the present invention.

### DETAILED DESCRIPTION

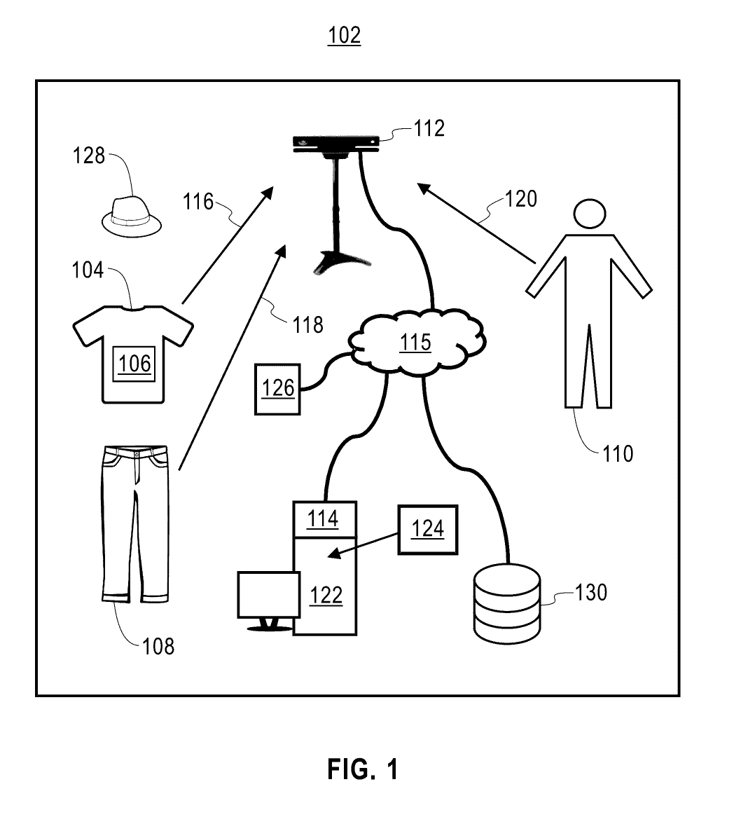

The present invention is described with reference to embodiments of the invention. Throughout the description of the invention reference is made to FIGS. 1-4. When referring to the figures, like structures and elements are indicated with like reference numerals.

Embodiments of the present invention manage household, electronics, and wearable items life-cycle. The invention may utilize passive labels or tags (without batteries) attached to each item, as well as image recognition algorithms applied on images extracted from the items. In order to manage the current state of the collection of items, sensors (at least one) are placed at several points of a user's house. These sensors keep pinging and logging the locations of the items.

A database is used to maintain records of all tags in use, and to store all the logs collected by the sensors. Periodically, analytics algorithms are run on the aforementioned database to detect which items should be replaced. A new item can be recommended based on an Internet search. Historical usage of items can be logged and analytics run from time to time to detect those items that should be replaced by another item in the house or purchased, i.e., replaced by a new one.

An Internet search based on the detected items can be performed for a replacement item recommendation. The recommended replacement item can be displayed to the user for evaluation and purchase. Embodiments of the invention may use augmented reality to help the user evaluate whether the recommended replacement is preferred. For example, a recommended replacement shirt may be displayed in a mirror so that the user may better visualize how the shirt will look. Embodiments of the invention may include an input device to allow the user to select from one of several recommended replacement items and purchase one or more of the recommended replacement items.

FIG. 1 shows one embodiment of a system for managing items, as contemplated by the present invention. The system includes a building 102 with a first physical object 104. A transmitter 106 is coupled to the first physical object 106. The transmitter 106 is configured to transmit an identification of the first physical object 104. The transmitter 106 may be passive or active. A passive transmitter, such as a passive RFID tag or a barcode, does not require power to transmit the identification of the first physical object 104. An active transmitter, such as a Bluetooth transmitter, does require power to transmit the identification of the first physical object 104.

The system further includes a second physical object 108 in the building 102. The second physical object 108 may also include a transmitter configured to transmit an identification of the second physical object 108. The system may also include a person 110 in the building 102.

A sensor 112 is configured to identify the first physical object 104 and the second physical object 108 in the building 102. In one embodiment, the sensor 112 is also configured to identify the person 110. The sensor 112 may include a receiver to receive an identification 116 transmitted by the transmitter 106. In one embodiment, the sensor 112 may include a camera and may use object recognition algorithms, such as scale-invariant feature transform (SIFT), to help identify objects and people.

The system includes a computer interface 114 in communication with the sensor 112 via a computer network 115. The computer interface 114 receives an identification 116 of the first physical object 104 and an identification 118 of the second physical object 108 from the sensor 112. The computer interface 114 may also receive an identification 120 of the person 110 from the sensor 112.

A computer 122 with at least one central processing unit (CPU) 124 is configured to automatically search for trend information 126 about the first physical object 104. In one embodiment, the trend information 126 may include the frequency that the first physical object 104 is discussed on one or more websites during a unit of time. In another embodiment, the trend information 126 may include a frequency that the first physical object 104 is discussed in a social network of the person 110 during a unit of time (e.g., day, week, month or year).

The computer 122 is further configured to determine an interaction between the first physical object 104 and the second physical object 108 based on the identification 116 of the first physical object 104 and the identification 118 of the second physical object 108. In another embodiment, the computer 122 is configured to determine an interaction between the first physical object 104 and the person 110 based on the identification 116 of the first physical object 104 and the identification 120 of the person 110. Additionally, the computer can recommend disposition of the first physical object 104 based, in part, on an interaction between the first physical object 104 and the person 110, and the trend information about the first physical object 126.

The computer 122 is also configured to recommend disposition of the first physical object 104 based, in part, on the interaction between the first physical object 104 and the second physical object 108, and the trend information 126 about the first physical object 104. For example, if the first physical object 104 and the second physical object 108 can be articles of clothing, and the trend information 126 indicates that the frequency at which the combination of the two objects are mentioned together is below a threshold value (i.e., the combination is no longer in style). Thus, the computer 122 can recommend disposition of the first physical object 104 based on the interaction and trend information for the objects.

In one embodiment, the computer 122 is configured to recommend a replacement object 128 for the first physical object 104 based, in part, on the interaction between the first physical object 104 and the second physical object 108, and the trend information 126 about the first physical object 104. Furthermore, the computer 122 can recommend a replacement object 128 for the first physical object 104 based, in part, on an interaction between the first physical object 104 and the person 110, and the trend information 126 about the first physical object 104.

The system includes a database 130 to store information about the physical objects and people. For example, the database 130 may store identification information for the first physical object 104 and the second physical object 108, descriptive information about the first physical object 104 and the second physical object 108, time of ownership information about the first physical object 104 and the second physical object 108, and descriptive information about an interaction between the first physical object 104 and the second physical object 108. The database 130 may additionally store descriptive information about the person 110 and descriptive information about an interaction between the first physical object 104 and the person 110.

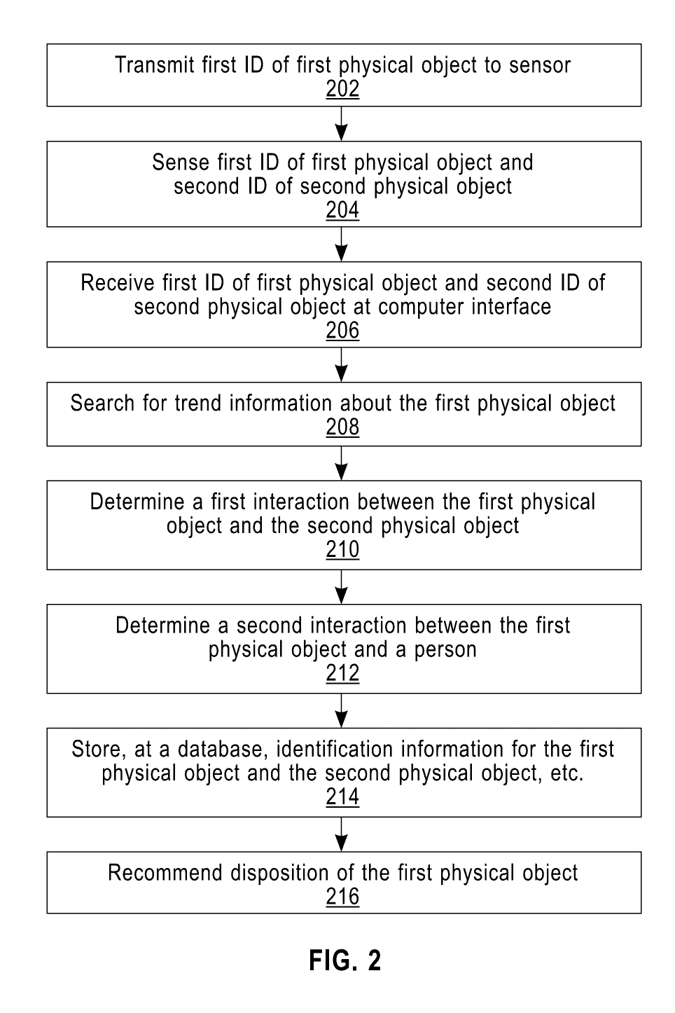

FIG. 2 shows one embodiment of a method for managing items, as contemplated by the present invention. The method includes transmitting operation 202. During this operation, a first identification of a first physical object is transmitted by a transmitter to a sensor. After transmitting operation 202, control passes to sensing operation 204.

At sensing operation 204, a sensor senses the first identification of a first physical object and a second identification of a second physical object in a building. After sensing operation 204, control passes to receiving operation 206. It is contemplated that passive labels/tags may be placed on objects. As discussed below, a database may contain records of all tags in use. The system may include sensors located in several points of the home and keep pinging and logging the items receiving the locations as signals. The database can be used to store all the logs collected by the sensors. In one embodiment, items are recognized with image recognition.

At receiving operation 206, the first identification of the first physical object and the second identification of the second physical object are received at a computer interface in communication with the sensor. After receiving operation 206, control passes to searching operation 208.

At searching operation 208, trend information about the first physical object is automatically searched for by the computer. In one embodiment, the trend information about the first physical object includes a frequency that the first physical object is discussed on one or more websites during a unit of time. In another embodiment, the trend information about the first physical object includes a frequency that the first physical object is discussed in a social network of the first physical object user during a unit of time. After searching operation 208, control passes to determining operation 210.

At determining operation 210, a first interaction between the first physical object and the second physical object is determined based on the first identification of the first physical object and a second identification of the second physical object. After determining operation 210, control passes to determining operation 212.

At determining operation 212, a second interaction is determined between the first physical object and a person based on the first identification of the first physical object and a third identification of the person. After determining operation 212, control passes to storing operation 214.

At storing operation 214, a database stores identification information for the first physical object and the second physical object, descriptive information about the first physical object and the second physical object, time of ownership information about the first physical object and the second physical object, and descriptive information about the first interaction between the first physical object and the second physical object. The database may further store descriptive information about the person and descriptive information about the second interaction between the first physical object and the person. After storing operation 214, control passes to recommending operation 216.

At recommending operation 216, disposition of the first physical object is recommended based, in part, on the first interaction between the first physical object and the second physical object and the trend information about the first physical object. In one embodiment, the recommended disposition is based, in part, on the second interaction between the first physical object and the person and the trend information about the first physical object. In another embodiment, the disposition of the first physical object includes recommending a replacement object for the first physical object.

It is contemplated that the system can provide a description of the object to be bought for replacement together with how to buy it. The recommendation can be displayed in the item, in a mirror, or in another item in the house with an ability to present the results and allow the user to confirm the buying intention (e.g., user can click on top of one of the recommended object), or using a speech recognition system, to allow the user to speak the intention to buy it, and after that buy it, if the case. The system can also be configured to automatically buy the object if the user would like to and has predefined her credit card information and home address.

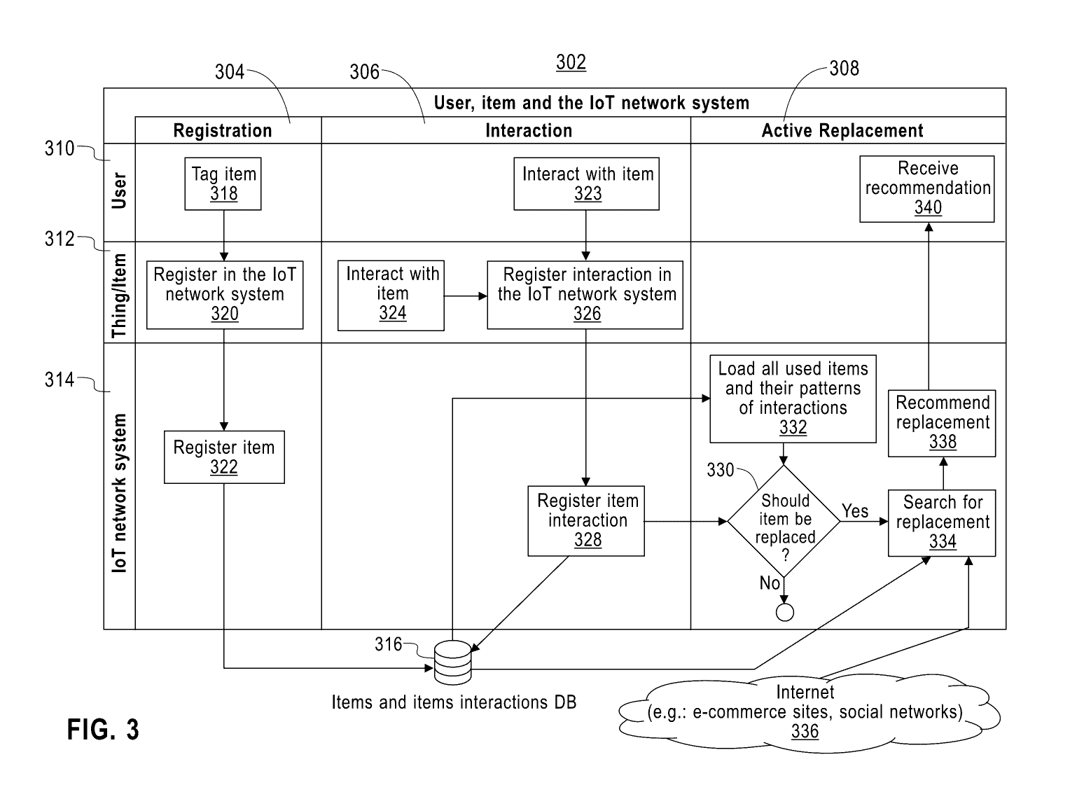

FIG. 3 shows another system 302 for managing items, as contemplated by the present invention. The system 302 is divided into three general phases-a registration phase 304, an interaction phase 306, and an active replacement phase 308. Each phase may be associated with a user 310, an item 312, and/or an Internet of Things (IoT) network system 314.

During the registration phase 304, the user 310 may register with the system 302. This process may include entering information about the user, such as demographics information, identification information, and social network information. User registration may include storing images and other biometrics of the user in a database 316 for automatic identification by the system 302. Table 1 shows an example table stored in the database 316 for user registration.

TABLE 1

| User ID | Name | Role |
|---|---|---|
| 1 | Bob | Father |
| 2 | Alice | Mother |

The registration phase 304 may include a tagging operation 318. During this operation, the user 310 may manually tag or identify one or more items 312 to be tracked by the system 302. The system 302 may store the identification information about the items 312 in the database 316. Table 2 shows an example table stored in the database 316 for item registration.

TABLE 2

| | | | Owner | | | |
|---|---|---|---|---|---|---|
| Object | De- | Acquisition | User | Fabrication | | |
| ID | scription | date | ID | date | Brand | . . . |
| 1 | Jacket | 18 Feb. 2015 | 1 | December/ | Nike | |
| | | | | 2014 | | |
| 2 | Ipad | 1 Jan. 2015 | 2 | July/2014 | Apple | |
| 3 | Washing | 3 Mar. 2014 | 1 | January/2013 | LG | |
| | machine | | | | | |

The registration phase 304 may include registration operation 320. During this operation, items 312 are automatically registered at an IoT network system 314. It is contemplated that the IoT network system 314 can be used to discover trend information for items 312. The registration phase 304 may further include registration operation 322. During this operation 322, the IoT network system 314, in response to registration operation 320, registers the items 314.

At interaction operation 323, a user 310 interacts with an item 312. At interaction 324, a first item 312 interacts with a second item 312. Both types of interactions are registered at the IoT network system 314 during registration operation 326. At registration 328, the IoT network system 314 responds by registering the interactions. The interactions may also be stored in the database 316. Table 3 shows an example table stored in the database 316 for recoding interactions.

TABLE 3

| | | | Inter. | Inter. | | Time | Durat. |
|---|---|---|---|---|---|---|---|
| Inter. | Obj | Inter. | Object | User | Date of | of | of |
| ID | ID | Type | ID | ID | Inter. | Inter. | Inter. |
| 1 | 1 | Wearing | Null | 1 | 5 May 2015 | 09:00 | 8 hrs |
| 2 | 1 | Washing | 3 | Null | 6 May 2015 | 10:00 | 1 hr |

At decision operation 330, the system 302 determines if an item 312 should be replaced based on the registered interactions. The decision operation 320 may be based, in part, on loading operation 332. Load operation 332 receives all used items and their patterns of interactions from the database 316. Examples of events that may trigger replacements are shifts in fashion/trends (system checks how many users have similar items over the last months), friends trends (system checks how many friends have used similar items over the last months), conflicts with friends (system notifies about friends who are using the same piece of clothing on that day), or, and not limited to, an event type (retailer notifies about special prices for items which are similar to those who reached certain usage thresholds, such as time of use). Determining item trends can be implemented, for example, by a trends object table shown in Table 4 and trends source table shown in Table 5.

TABLE 4

| Trend Object | | Fabrication | |
|---|---|---|---|
| ID | Description | Date | Brand |
| 1 | Jacket | July/2015 | Nike |
| 2 | Ipad | July/2015 | Apple |

TABLE 5

| Source ID | Type of Source | Name | URL |
|---|---|---|---|
| 1 | News | NY Fashion Week | http:// . . . |
| 2 | Social Media | Bob's social | http:// . . . |
| | | network | (friend's |
| | | | profile) |

Based on the interactions table and the trend tables, the system 302 can calculate the likelihood of replacing the item 312. Any method for estimating the likelihood that the user 310 would like to replace the item 312 could be used, such as the Expectation-Maximization (EM) algorithm. Table 6 shows an example trend search correlation table for determining the likelihood of replacing the item 312.

TABLE 6

| Trend Object ID | Source ID | Match |
|---|---|---|
| 1 | 1 | 95% |
| 2 | 2 | 100% |

If the system determines that the item 312 should be replaced, search operation 334 performs a search for candidate replacement items. The search may locate replacement items over the Internet 336 and/or query the database 316. At recommendation operation 338, one or more candidate replacement items are compiled by the system 302. In one embodiment, candidate replacement items can be displayed in computer monitor, in a mirror (e.g., augmented reality), or in another item in the house, with an ability to click or with an ability to recognize the user's speech and, after that, to buy. At receiving operation 340, the candidate replacement items are received by the user 310.

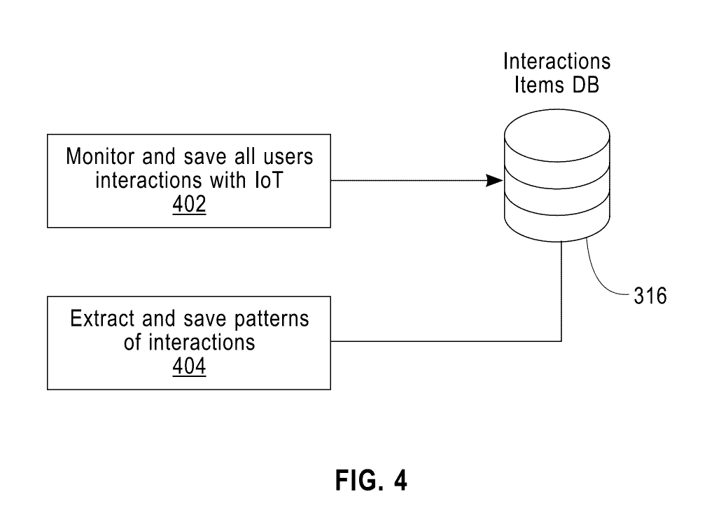

FIG. 4 shows one embodiment for managing interactions by the system. At monitoring operation 402, user-to-item interactions and item-to-item interactions are monitored and stored in the database 316. At extracting operation 404, interaction patterns are extracted and stored in the database 316. In this manner, historical use of items can be logged and analytics can be performed from time to time to detect items that should be replaced or purchased.

Accordingly, embodiment of the present may include one or more computers and one or more computer interfaces for receiving identification information for one or more objects in a household. The system may further include a database with the identification information for the objects along with object descriptive information, time of ownership information about the object, and descriptive information about interactions between the objects and people. One or more interfaces may receive and/or automatically search for trend information from several types of sources. A correlating engine can determine current information about an object by comparing its descriptive information, time of ownership information, and interactions (with other objects and/or people) with the trend information to determine life cycle information about the object. The system can provide a user with recommendations about the object based on the life cycle information.

In one embodiment, the system may include sensors for identifying physical objects in an environment. A computer interface in communication with the sensors is configured to receive identification of the different physical objects. Given an object, a computer with at least one central processing unit is configured to automatically search for trend information about the object, determine an interaction between the given object and the other objects (based on the identification of different objects), recommend disposition of the object based on the interactions, and the trend information about the object.

It is contemplated that the objects can be household items, clothing, electronics, wearables, furniture, and/or any object that a person can own and register at home. The trend information may include searches of friend's trends, events, fashion information, object functional information, news websites, social media, and/or any source of information that the objects' owner provides.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present invention may be embodied as a system, method, or computer program product. Accordingly, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for managing items, the system comprising:
a sensor for identifying a first physical object and a second physical object in a building;
a computer interface in communication with the sensor to receive a first identification of the first physical object and a second identification of the second physical object; and
a computer including at least one central processing unit, the computer to:
automatically search for trend information about the first physical object;
determine a first interaction between the first physical object and the second physical object based on the first identification of the first physical object and the second identification of the second physical object; and
recommend disposition of the first physical object based on at least the first interaction between the first physical object and the second physical object, and the trend information about the first physical object.

2. The system of claim 1, wherein the computer is configured to recommend a replacement object for the first physical object based on at least the first interaction between the first physical object and the second physical object, and the trend information about the first physical object.

3. The system of claim 1, further comprising a database to store identification information for the first physical object and the second physical object, descriptive information about the first physical object and the second physical object, time of ownership information about the first physical object and the second physical object, and descriptive information about the first interaction between the first physical object and the second physical object.

4. The system of claim 1, wherein the trend information about the first physical object includes a frequency that the first physical object is discussed on one or more websites during a unit of time.

5. The system of claim 1, wherein the computer is configured to:
determine a second interaction between the first physical object and a person based on the first identification of the first physical object and a third identification of the person; and
recommend disposition of the first physical object based on at least the second interaction between the first physical object and the person, and the trend information about the first physical object.

6. The system of claim 5, wherein the computer is configured to recommend a replacement object for the first physical object based on at least the second interaction between the first physical object and the person, and the trend information about the first physical object.

7. The system of claim 5, wherein the trend information about the first physical object includes a frequency that the first physical object is discussed in a social network of the person during a unit of time.

8. The system of claim 5, further comprising a database to store identification information for the first physical object and the second physical object, descriptive information about the first physical object and the second physical object, descriptive information about the person, time of ownership information about the first physical object and the second physical object, and descriptive information about the second interaction between the first physical object and the person.

9. The system of claim 1, further comprising a transmitter coupled to the first physical object to transmit the first identification of the first physical object to the sensor.

10. A method for managing items, the method comprising:
sensing by a sensor a first identification of a first physical object and a second identification of a second physical object in a building;
receiving at a computer interface in communication with the sensor the first identification of the first physical object and the second identification of the second physical object;
automatically searching for trend information about the first physical object;
determining a first interaction between the first physical object and the second physical object based on the first identification of the first physical object and the second identification of the second physical object; and
recommending disposition of the first physical object based on at least the first interaction between the first physical object and the second physical object, and the trend information about the first physical object.

11. The method of claim 10, wherein recommending disposition of the first physical object includes recommending a replacement object for the first physical object based on at least the first interaction between the first physical object and the second physical object, and the trend information about the first physical object.

12. The method of claim 10, further comprising storing, at a database, identification information for the first physical object and the second physical object, descriptive information about the first physical object and the second physical object, time of ownership information about the first physical object and the second physical object, and descriptive information about the first interaction between the first physical object and the second physical object.

13. The method of claim 10, wherein the trend information about the first physical object includes a frequency that the first physical object is discussed on one or more websites during a unit of time.

14. The method of claim 10, further comprising:
determining a second interaction between the first physical object and a person based on the first identification of the first physical object and a third identification of the person; and
recommending disposition of the first physical object based on at least the second interaction between the first physical object and the person, and the trend information about the first physical object.

15. The method of claim 14, further comprising recommending a replacement for the first physical object based on at least the second interaction between the first physical object and the person, and the trend information about the first physical object.

16. The method of claim 14, wherein the trend information about the first physical object includes a frequency that the first physical object is discussed in a social network of the person during a unit of time.

17. The method of claim 14, further comprising storing, at a database, identification information for the first physical object and the second physical object, descriptive information about the first physical object and the second physical object, descriptive information about the person, time of ownership information about the first physical object and the second physical object, and descriptive information about the second interaction between the first physical object and the person.

18. The method of claim 10, further comprising transmitting by a transmitter coupled to the first physical object the first identification of the first physical object to the sensor.

19. A computer program product for monitoring traffic characteristics between gateways in a computer network, the computer program product comprising:
a non-transitory computer readable storage medium having computer readable program code embodied therewith, the computer readable program code configured to:
receive at a computer interface in communication with a sensor a first identification of a first physical object and a second identification of a second physical object;
automatically search for trend information about the first physical object;
determine a first interaction between the first physical object and the second physical object based on the first identification of the first physical object and the second identification of the second physical object;
recommend disposition of the first physical object based on at least the first interaction between the first physical object and the second physical object, and the trend information about the first physical object; and
store at a database identification information for the first physical object and the second physical object, descriptive information about the first physical object and the second physical object, time of ownership information about the first physical object and the second physical object, and descriptive information about the first interaction between the first physical object and the second physical object.

20. The computer program product of claim 19, wherein the computer readable program code is further configured to:
determine a second interaction between the first physical object and a person based on the first identification of the first physical object and a third identification of the person; and
recommend disposition of the first physical object based on at least the second interaction between the first physical object and the person, and the trend information about the first physical object; and
store at the database descriptive information about the person, and descriptive information about the second interaction between the first physical object and the person.
